(19) United States
(12) Patent Application Publication
(10) Pub. No.: US 2017/0315797 A1
(43) Pub. Date: Nov. 2, 2017

(54) VEHICLE CONNECTION LOCATION REGIONAL SOFTWARE DELIVERY

(71) Applicant: FORD GLOBAL TECHNOLOGIES, LLC, Dearborn, MI (US)

(72) Inventor: John Naum VANGELOV, South Lyon, MI (US)

(21) Appl. No.: 15/144,165

(22) Filed: May 2, 2016

(51) Int. Cl. G06F 9/445; H04L 29/08

(52) U.S. Cl. CPC G06F 8/65; H04L 67/12; H04L 67/34

(57) ABSTRACT

A server identifies, based on an originating address of a request from a vehicle for software updates, a regional software delivery network to serve the software updates to the vehicle. The server determines the software updates to apply to the vehicle based on an interrogator log included in the request, and sends a manifest to the vehicle including links to the software updates served by the regional software delivery network. A network address of an update request from a vehicle may be mapped to a geographic region. A regional software delivery network serving the geographic region may be identified. A manifest including links to software updates served by the regional software delivery network may be sent to the vehicle, the manifest generated based on an interrogator log included in the update request.

### TECHNICAL FIELD

The illustrative embodiments generally relate to a method and apparatus for regional delivery of software updates based on vehicle connection network location.

### BACKGROUND

To update a software version of a component of a vehicle, the vehicle may be driven to a dealership and serviced by a technician. The technician may utilize a system that tracks the individual software levels of every component in the vehicle as well as available software updates. The technician may manually apply the software updates indicated by the system and record any changes back into the system.

Over-the-air (OTA) software updates are a technique by which software of a vehicle may be updated via a wireless connection. Using an embedded modem or other wireless data connection to the vehicle, OTA updates allow software changes on vehicle electronic control units (ECUs) without a dealership visit.

### SUMMARY

In a first illustrative embodiment, a system includes a server programmed to identify, based on an originating address of a request from a vehicle for software updates, a regional software delivery network to serve the software updates to the vehicle, determine the software updates to apply to the vehicle based on the request, and send a manifest to the vehicle including links to the software updates served by the regional software delivery network.

In a second illustrative embodiment, a method includes mapping a network address of an update request from a vehicle to a geographic region; identifying a regional software delivery network serving the geographic region; and sending a response including links to software updates served by the regional software delivery network to the vehicle, the response generated based on information included in the update request.

In a third illustrative embodiment, a non-transitory computer-readable medium storing instructions that, when executed by at least one processor of a server, cause the server to identify, based on an originating Internet Protocol (IP) address of a secure hypertext protocol (HTTPS) connection from a vehicle, a regional software delivery network to serve the software updates to the vehicle; determine the software updates to apply to the vehicle based on an interrogator log received from the vehicle over the connection; and send a manifest to the vehicle including web links to the software updates served by the regional software delivery network.

### BRIEF DESCRIPTION OF THE DRAWINGS

FIG. 1 illustrates an example block topology for a vehicle-based computing platform;

FIG. 2 illustrates an exemplary diagram of an in-vehicle software update server and multiple regional software delivery networks in communication over the network with a vehicle;

FIG. 3 illustrates an example data flow diagram illustrating the delivery of software updates using the regional software delivery networks;

FIGS. 4A, 4B, and 4C each illustrate example manifests including links for two software updates;

FIG. 5 illustrates an example process for updating software of the computing platform using a regional software delivery network; and

FIG. 6 illustrates an example process for providing software updates to a vehicle from a regional software delivery network.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A system may perform over-the-air download and installation of software updates to vehicle components. The system may install the updates into a parallel software installation separate from an active software installation (such as a partition other than the active software partition or a parallel set of files and/or directories other than an active set of files). When the installation is complete, the system may switch the active software installation to be the second parallel software installation. In some cases, the system may provide a notification to the user that the software has been updated. This allows for the software to be updated without requiring customer interaction to invoke the update process, and without causing the customer to be unable to utilize the software systems while an update is being performed.

The vehicle may generate an interrogator log based upon a determination to check for software updates. The interrogator log may include version information of at least one hardware or software module installed on the vehicle, and may be used to determine what modules to update. The interrogator log may include information compiled in accordance with a data identifier list defining what information to include in the interrogator log and where such information is located in the active software installation.

The vehicle may send the interrogator log to the in-vehicle software update server (IVSU) server. In an example, the vehicle may send the interrogator log to an address of the IVSU over a secure hyper-text transport protocol (HTTPS) connection (e.g., via an HTTPS post). The IVSU may receive the interrogator log, and respond to the vehicle with a manifest based on the information included in the interrogator log. The manifest may indicate web server locations of at least one software update to be installed by the vehicle, and may be provided back to the vehicle over HTTPS. Based on the manifest, the vehicle may install updated binaries and/or configurations retrieved from the specified web server locations.

When performing software updates in locations across the globe, it may be desirable to have the software updates be downloaded from locations geographically similar to vehicle location. In one example approach, the vehicle components may include hard-coded regional information intended to be reported to the IVSU for generation of the manifest. However, such an approach may be unable to account for vehicles being transported to different regions (e.g., from the United States to China), or for changing definitions of regions (e.g., North America being split into East and West logical update regions after vehicle assembly).

Rather than relying on hardcoded location information, the IVSU may determine a location for the vehicle based on the origination address (e.g., Internet protocol (IP address) of the connection over which the vehicle provided the interrogator log. Using the origination address, the IVSU may derive the country or region from which the update request was received. Using the identified region, when generating the manifest the IVSU may populate the download locations in the manifest with network locations for the derived country or region. For instance, for a vehicle presently located in China based on the originating IP address of the interrogator log, the IVSU may generate a manifest including updates hosted by a software delivery network within the China region. Further aspects of the disclosed concepts are described in detail herein.

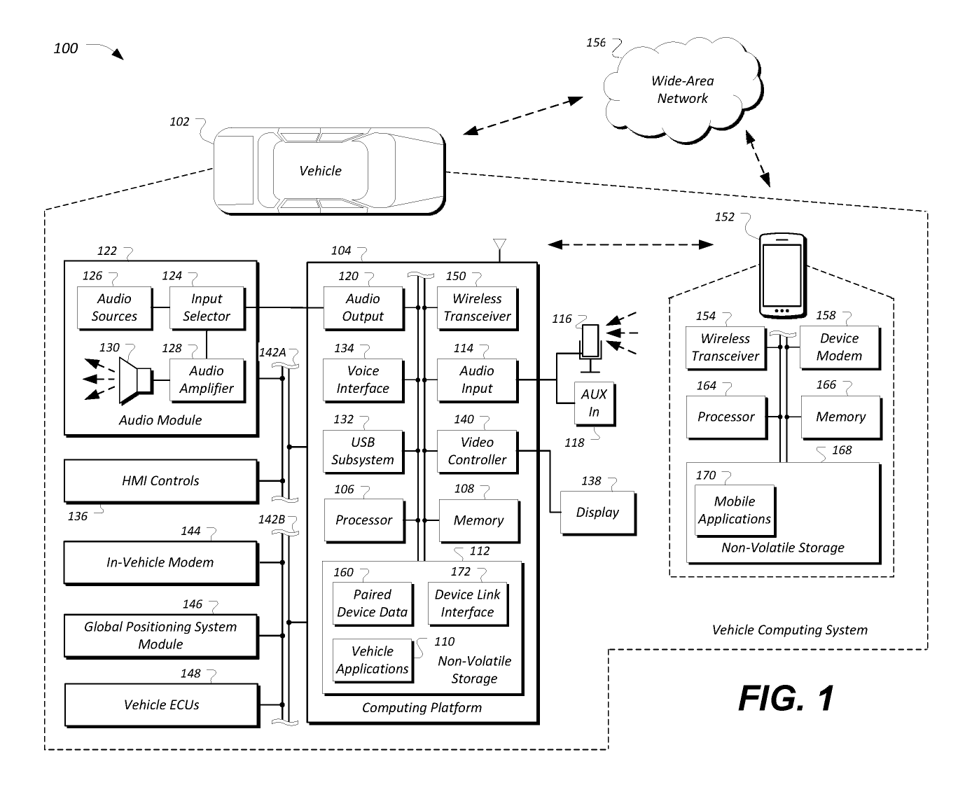

FIG. 1 illustrates an example diagram of a system 100 that may be used to provide telematics services to a vehicle 102. The vehicle 102 may be of various types of passenger vehicles, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, Mich. It should be noted that the illustrated system 100 is merely an example, and more, fewer, and/or differently located elements may be used.

The computing platform 104 may include one or more processors 106 connected with both a memory 108 and a computer-readable storage medium 112 and configured to perform instructions, commands, and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory (e.g., tangible) medium that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a wired jack, such as a stereo input, or a wireless input, such as a BLUETOOTH® audio connection. In some examples, the audio input 114 may be configure to provide audio processing capabilities, such as pre-amplification of low-level signals, and conversion of analog inputs into digital data for processing by the processor 106.

The computing platform 104 may also provide one or more audio outputs 120 to an input of the audio playback functionality of the audio module 122. In other examples, the computing platform 104 may provide audio output to the occupants through use of one or more dedicated speakers (not illustrated). The audio module 122 may include an input selector 124 configured to provide audio content from a selected audio source 126 to an audio amplifier 128 for playback through vehicle speakers 130. The audio sources 126 may include, as some examples, decoded amplitude modulated (AM) or frequency modulated (FM) radio signals, and compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. The voice interface 134 may support speech recognition from audio received via the microphone 116 according to a grammar of available commands, and voice prompt generation for output via the audio module 122. In some cases, the system may be configured to temporarily mute, fade, or otherwise override the audio source specified by the input selector 124 when an audio prompt is ready for presentation by the computing platform 104 and another audio source 126 is selected for playback.

The computing platform 104 may also receive input from human-machine interface (HMI) controls 136 configured to provide for occupant interaction with the vehicle 102. For instance, the computing platform 104 may interface with one or more buttons or other HMI controls configured to invoke computing platform 104 functions (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, or a media oriented system transfer (MOST), as some examples. The in-vehicle networks 142 may allow the computing platform 104 to communicate with other vehicle 102 systems, such as an vehicle modem 144 (which may not be present in some configurations), a global positioning system (GPS) module 146 configured to provide current vehicle 102 location and heading information, and various vehicle electronic control units (ECUs) 148 configured to provide other types of information regarding the systems of the vehicle 102. As some non-limiting possibilities, the vehicle ECUs 148 may include a powertrain controller configured to provide control of engine operating components (e.g., idle control components, fuel delivery components, emissions control components, etc.) and monitoring of engine operating components (e.g., status of engine diagnostic codes); a body controller configured to manage various power control functions such as exterior lighting, interior lighting, keyless entry, remote start, and point of access status verification (e.g., closure status of the hood, doors, and/or trunk of the vehicle 102); a radio transceiver configured to communicate with key fobs or other local vehicle 102 devices; and a climate control management controller configured to provide control and monitoring of heating and cooling system components (e.g., compressor clutch and blower fan control, temperature sensor information, etc.).

As shown, the audio module 122 and the HMI controls 136 may communicate with the computing platform 104 over a first in-vehicle network 142A, and the vehicle modem 144, GPS module 146, and vehicle ECUs 148 may communicate with the computing platform 104 over a second in-vehicle network 142B. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, or other devices capable of communication with the computing platform 104. In many examples, the computing platform 104 may include a wireless transceiver 150 (e.g., a BLUETOOTH® module, a ZIGBEE® transceiver, a Wi-Fi transceiver, etc.) configured to communicate with a compatible wireless transceiver 154 of the mobile device 152. Additionally or alternately, the computing platform 104 may communicate with the mobile device 152 over a wired connection, such as via a USB connection between the mobile device 152 and the USB subsystem 132.

The wide-area network 156 may provide communications services, such as packet-switched network services (e.g., Internet access, VoIP communication services), to devices connected to the wide-area network 156. An example of a wide-area network 156 may include a cellular telephone network. Mobile devices 152 may provide network connectivity to the wide-area network 156 via a device modem 158 of the mobile device 152. To facilitate the communications over the wide-area network 156, mobile devices 152 may be associated with unique device identifiers (e.g., media access control (MAC) addresses, mobile device numbers (MDNs), Internet protocol (IP) addresses, mobile station international subscriber directory numbers (MSISDNs), international mobile subscriber identity (IMSI), etc.) to identify the communications of the mobile devices 152 over the wide-area network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, secret information shared between the paired mobile device 152 and the computing platform 104 such as link keys, and/or personal identification numbers (PINs), and most recently used or device priority information, such that the computing platform 104 may automatically reconnect to the mobile devices 152 matching data in the paired device data 160 without user intervention. In some cases, the paired device data 160 may also indicate additional information or options related to the permissions or functionality of the computing platform 104 that the paired mobile device 152 is authorized to access when connected.

When a paired mobile device 152 that supports network connectivity is automatically or manually connected to the computing platform 104, the mobile device 152 may allow the computing platform 104 to use the network connectivity of the device modem 158 to communicate over the wide-area network 156. In one example, the computing platform 104 may utilize a data-over-voice connection over a voice call or a data connection of the mobile device 152 to communicate information between the computing platform 104 and the wide-area network 156. Additionally or alternately, the computing platform 104 may utilize the vehicle modem 144 to communicate information between the computing platform 104 and the wide-area network 156, without use of the communications facilities of the mobile device 152.

Similar to the computing platform 104, the mobile device 152 may include one or more processors 164 configured to execute instructions of mobile applications 170 loaded to a memory 166 of the mobile device 152 from storage medium 168 of the mobile device 152. In some examples, the mobile applications 170 may be configured to communicate with the computing platform 104 or other locally-networked devices and with the wide-area network 156.

The computing platform 104 may also include a device link interface 172 to facilitate the integration of functionality of the mobile applications 170 into the grammar of commands available via the voice interface 134. The device link interface 172 may also provide the mobile applications 170 with access to vehicle features, such as information available to the computing platform 104 via the in-vehicle networks 142 or access to the display 138. An example of a device link interface 172 may be the SYNC APPLINK component of the SYNC system provided by The Ford Motor Company of Dearborn, Mich.

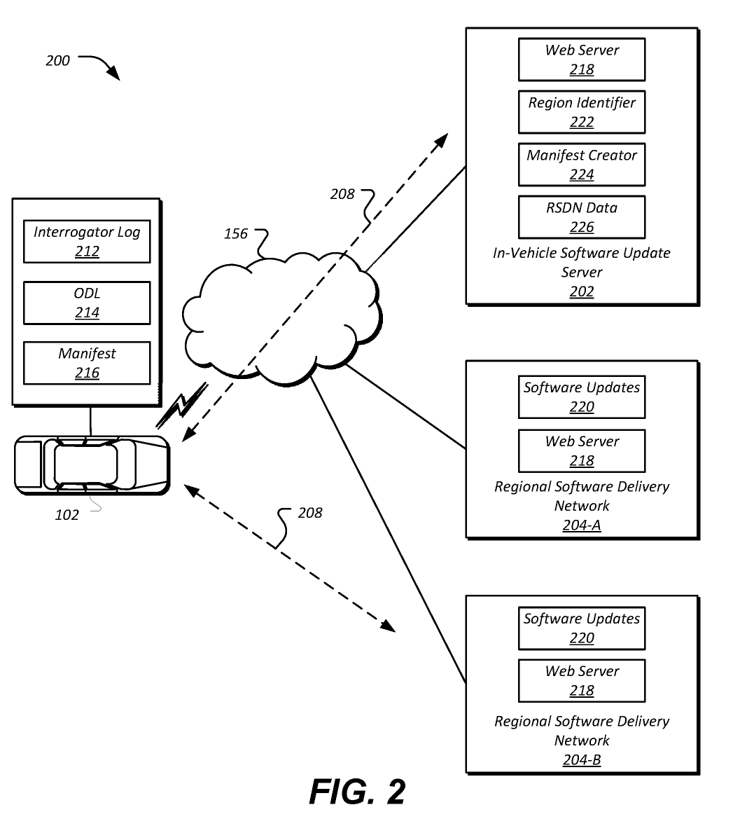

FIG. 2 illustrates an exemplary diagram 200 of an IVSU 202 and multiple regional software delivery networks 204 in communication over the network 156 with a vehicle 102. The vehicle 102 may be in wireless communication with the network 156 by way of the computing platform 104 of the vehicle 102. When a vehicle 102 is assembled, the vehicle 102 may include various hardware and software components. Upon or after assembly, the computing platform 104 of the vehicle 102 may be configured to query for existence and version information for at least a portion of these hardware and software components of the vehicle 102. Using the queried information and additional information identifying the specific vehicle 102 (e.g., vehicle identification number (VIN) information published on the car area network (CAN) bus, subscriber identity module (SIM) information of the vehicle modem 144 such as international mobile station equipment identity (IMEI), etc.), the computing platform 104 may communicate via the network 156 to establish an account with the IVSU 202. The IVSU 202 may receive these communications from the vehicles 102, and may maintain a data store of the hardware configurations and software (e.g., firmware, etc.) versions linked to identifiers of the vehicles 102.

The software updates 220 may include changes to the software or settings of the vehicle 102 to address an issue with the current software or settings, or to provide improved functionality to the current software. The software updates 220 may include, for example, updated configuration settings for one or more vehicle ECUs 148, and/or updated versions of software or firmware to be installed on one or more vehicle ECUs 148. In some cases software updates 220 may include a single section, while in other cases software updates 220 may be organized into multiple subsections, partitions, or chunks, where all the subsections may be downloaded to complete the overall software update 220 to be installed. In some examples, the software updates 220 may be originated by a vendor (e.g., of the vehicle ECU 148) or originated by the vehicle manufacturer. In some cases, the software updates 220 may be encrypted, while in other cases the software updates 220 may not be encrypted.

The regional software delivery networks 204 may be located in a different geographic region. Each regional software delivery network 204 may provide one or more web servers 218 for hosting the software updates 220 for download by the vehicles 102. The web servers 218 may include one or more devices configured to serve the software updates 220 stored by the regional software delivery network 204 to the vehicles 102. For example, the web servers 218 may be configured to receive the update requests for available software updates 220 from vehicles 102. To provide for better network performance, the regional software delivery networks 204 may be intended to serve the software updates 220 to vehicles 102 in the same region as the regional software delivery network 204.

The regional software delivery network (RSDN) data 226 may include information indicating which regional software delivery networks 204 are allocated for use in which regions. In an example, the RSDN data 226 may include a mapping of IP or other addresses of the regional software delivery networks 204 to identifiers of regions served by the respective regional software delivery networks 204.

The region identifier 222 may be configured to determine which of the regional software delivery networks 204 to use for which vehicles 102. In an example, the region identifier 222 may utilize IP geolocation to identify the current location of a vehicle 102 based on the IP address of the vehicle 102. As IP addresses are allocated geographically, by knowing the IP address of a vehicle 102, the region identifier 222 may be able to determine the country or even city in which the vehicle 102 is located. Using IP geolocation and the RSDN data 226, the region identifier 222 may be configured to determine which regional software delivery network 204 is intended to serve the software updates 220 for a vehicle 102 based on the IP address of the vehicle 102.

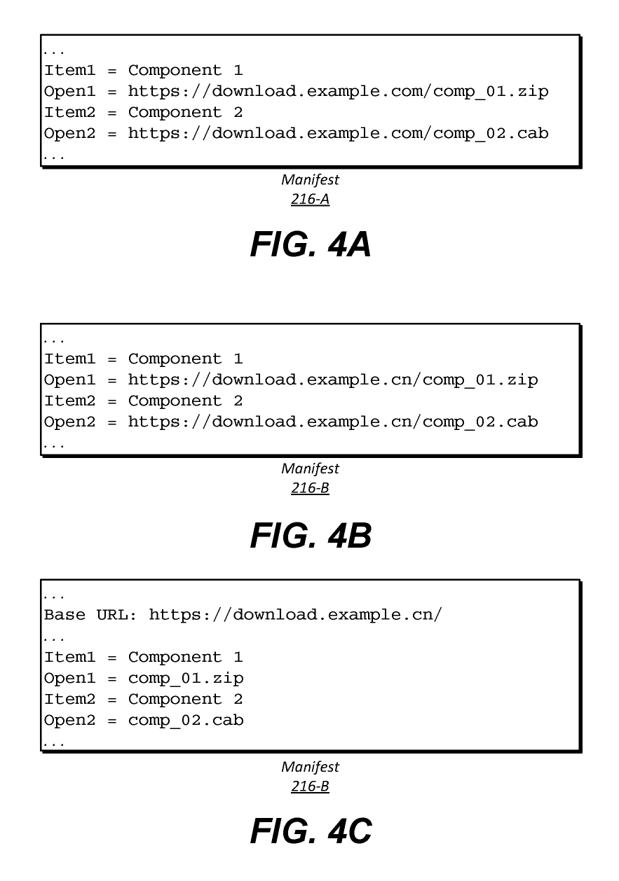

The manifest 216 may be a file or other data structure configured to identify binaries or other software updates 220 that should be installed to the vehicle 102. The manifest 216 may specify network locations at which each of the specified software updates 220 may be retrieved. As one example, the manifest 216 may specify the network locations as universal resource locators (URLs) served by web servers 218 of the one of the regional software delivery networks 204 in the same region as the vehicle 102. Example manifests 216 are discussed in greater detail with respect to FIGS. 4A-4C below.

The interrogator log 212 may be a file or other data structure including information collected from the vehicle 102 for use in identifying the current software version state of the vehicle 102. The information to interrogate may include, as some non-limiting examples, module name, module serial number, VIN, hardware part number, MAC address, part numbers of software applications, languages, and service packs installed on the module, available storage space on the module, and status information regarding the installation of previous updates.

The optimized data identifier list (ODL) file 214 may define the specific information to interrogate and where such information may be located. In some cases, the ODL file 214 may be installed as part of an installation of software on the computing platform 104, while in other cases the ODL file 214 may have been previously received according to earlier performed updates (described in greater detail below).

The manifest creator 224 may be configured to generate the manifest 216 using the interrogator log 212. To identify the software updates 220, the manifest creator 224 may be configured to compare the current versions of modules indicated in the interrogator log 212 with the latest version of the modules compatible with the computing platform 104. The manifest creator 224 may be further configured to identify, for any components that should be updated, any additional dependencies that those updated versions may require. Those additional dependencies may further be added to the manifest 216. Based on the regional software delivery network 204 intended to serve the software updates 220 identified by the region identifier 222, the manifest creator 224 may populate the download locations in the manifest 216 with network locations served by web servers 218 of the one of the regional software delivery networks 204 in the same region as the vehicle 102.

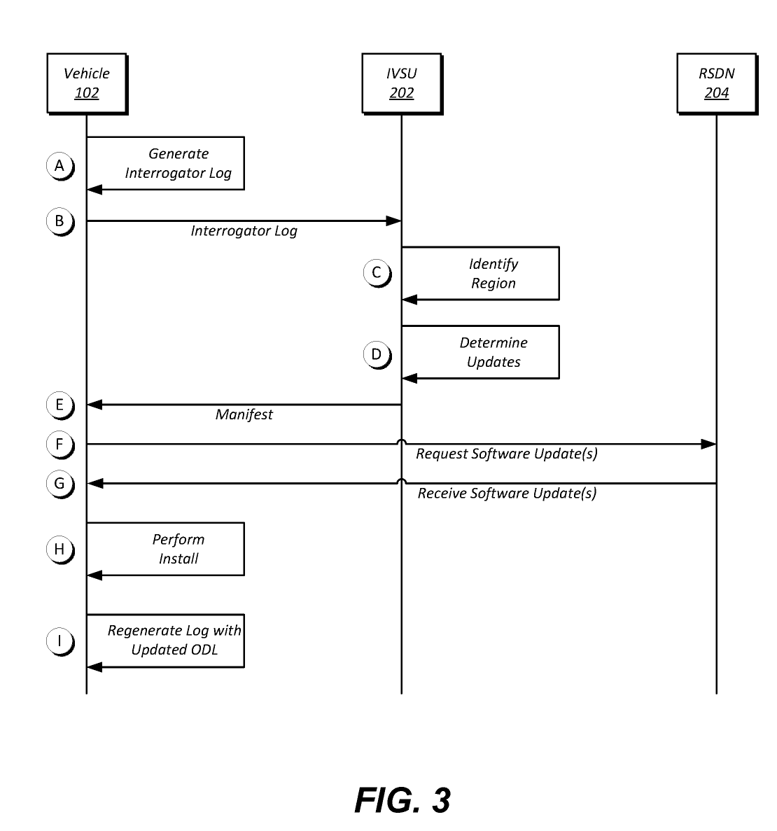

FIG. 3 illustrates an example data flow diagram 300 illustrating the delivery of software updates 220 using the regional software delivery networks 204. In an example, the data flow may be performed using a system such as illustrated in FIG. 2.

A user of the vehicle 102 may opt into download of software updates 220 being performed by the vehicle 102. To facilitate the opt-in process, in some examples the computing platform 104 may provide a prompt to the user via the display 138 and/or audio module 122 requesting the user's authorization. An exemplary prompt may request the user to consent to over-the-air software updates 220 to be performed via the in-vehicle modem 144 (or via WiFi or through a data connection of a connected mobile device 152). The consent may be requested once, but utilized across multiple update cycles. As another possibility, the user may opt into over-the-air software updates 220 using a mobile device 152 paired or otherwise associated with the vehicle 102 (e.g., by providing consent via a mobile application executed by the mobile device 152, via sending a short message service (SMS) message from the mobile device 152 to a specific number, by use of an authorization webpage accessible from the mobile device 152, etc.).

Once authorized (e.g., by way of receiving button presses or spoken dialog from the user), the computing platform 104 may be configured to query for software updates 220 for the vehicle ECUs 148. This querying may be performed silently, without requiring user input.

At time index (A), the computing platform 104 collects information related to the modules of the vehicle 102. The process of collecting data may be referred to as interrogation, and the collected data may be referred to as an interrogator log 212. The computing platform 104 may determine what information to collect using the ODL file 214. Notably, the information to collect may include data elements from the vehicle ECUs 148 or other controllers of the vehicle 102, and may be retrieved via the controller area network (CAN) or other vehicle 102 communication architecture supporting data transfer between controllers. The information may also include diagnostic codes and other vehicle state information that may be collected during vehicle 102 servicing by a dealer. The information may also include analytics data including usage and logging data providing insight into usage of various vehicle features. In some cases, the ODL file 214 may be installed as part of an installation of software on the computing platform 104, while in other cases the ODL file 214 may have been previously received according to earlier performed updates (described in greater detail below).

At time index (B), the computing platform 104 sends the interrogator log 212 to the IVSU 202. In an example, the computing platform 104 may send the interrogator log 212 to the IVSU 202 via HTTPS (e.g., by connection of the computing platform 104 to a predefined web address of the IVSU 202 known to the computing platform 104). The IVSU 202, accordingly, may receive the IVSU 202 from the vehicle 102.

At time index (C), the IVSU 202 determines a region for the vehicle 102 based on the origination address (e.g., Internet protocol (IP) address) of the connection over which the vehicle provides the interrogator log 212. Using the originating address and the RSDN data 226, the region identifier 222 of the IVSU 202 may derive the originating country or region for the update request. Accordingly, when generating the manifest 216, the manifest creator 224 of the IVSU 202 may populate the download locations in the manifest 216 with network locations for the regional software delivery network 204 in the derived country or region. For instance, for a vehicle 102 presently located in China based on the originating IP address of the interrogator log 212, the manifest creator 224 may generate the manifest 216 linking to software updates 220 hosted within the China regional software delivery network 204.

At time index (D), the IVSU 202 reviews the current module configuration and current version of the computing platform 104, and determines whether any software updates 220 to the vehicle 102 should be installed. Based on the determination, the IVSU 202 may identify software update 220 binaries that should be installed on the vehicle 102 to perform the identified updates. These binaries may be identified in a manifest 216. Moreover, the manifest 216 may specify network locations at which each of the specified update binaries may be retrieved. As one example, the manifest 216 may specify the network locations as URLs served by a web server 218 of the IVSU 202. In some cases, the binaries may include new versions of files to be installed, while in other cases, the binaries may include incremental updates to be applied to currently installed binaries to update the currently installed binaries from one version to a next version.

FIGS. 4A and 4B each illustrate example manifests 216 including links for two software updates 220. As shown, the manifest 216-A of FIG. 4A includes a link to a first software update 220 file “comp_01.zip” available from a first regional software delivery network 204 (e.g., the regional software delivery networks 204-A for sake of example) and a link to a second software update 220 file “comp_02.cab” also available from the first regional software delivery network 204. Similarly, the manifest 216-B of FIG. 4B includes links to the same files “comp_01.zip” and “comp_02.cab”, but from a second regional software delivery network 204 (e.g., the regional software delivery networks 204-B for sake of example). Accordingly, the manifest 216-A and 216-B each specify the same files, but from different download URL locations.

Variations on the example manifests 216 are possible. In another example, FIG. 4C illustrates a manifest 216-C including the same links as in the manifest 216-B, but specified including a base server URL, where each software update 220 is then specified as a relative link to the base server URL.

Referring back to FIG. 3, at time index (E) the IVSU 202 sends the manifest 216 to the vehicle 102. In an example, the IVSU 202 may send the manifest 216 to the vehicle 102 via HTTPS (e.g., over the HTTPS connection to which the computing platform 104 sent the interrogator log 212 to the computing platform 104, over a different connection to the same or a different predefined web address of the IVSU 202 known to the computing platform 104, etc.). Once received, the computing platform 104 may be configured to install the updates indicated by the manifest 216.

Based on the manifest 216, at time index (F) the computing platform 104 requests the software updates 220 (e.g., configuration files, binaries, etc.) from the link locations specified by the manifest 216. The software updates 220 may accordingly download the software updates 220 as shown at time index (G). As one example, the manifest 216 may specify the network locations as URLs served by a web server 218 of the IVSU 202, and the computing platform 104 may download the software update 220 from the URLs specified by the manifest 216. As the software updates 220 may be made available from the web server 218 via HTTPS, the computing platform 104 may be able to download the software updates 220 using resume functionality available for downloads from web servers 218.

At time index (H), the computing platform 104 installs the downloaded software updates 220. In some examples, to avoid disruption of the current version of software installed to the computing platform 104, the computing platform 104 may be configured to perform the installation to a second installation of the computing platform 104, other than the currently active installation from which the computing platform 104 was booted. The installation of the updates to the second installation may be performed silently, without requiring input from the user.

Upon completion of installation of the software updates specified by the manifest 216, the computing platform 104 may be configured to perform an additional interrogation of the modules of the vehicle 102 to create a new interrogator log 212. Similar to as describe above, at time index (I) the computing platform 104 may create the interrogator log 212, but this time utilizing the received ODL 214, providing an updated definition of what information to interrogate for the currently performed software updates 220. The computing platform 104 may be configured to send the interrogator log 212 to the IVSU 202, e.g., via HTTPS. Accordingly, the IVSU 202 may be automatically updated with the installation status of the vehicle 102, without requiring user HMI interaction.

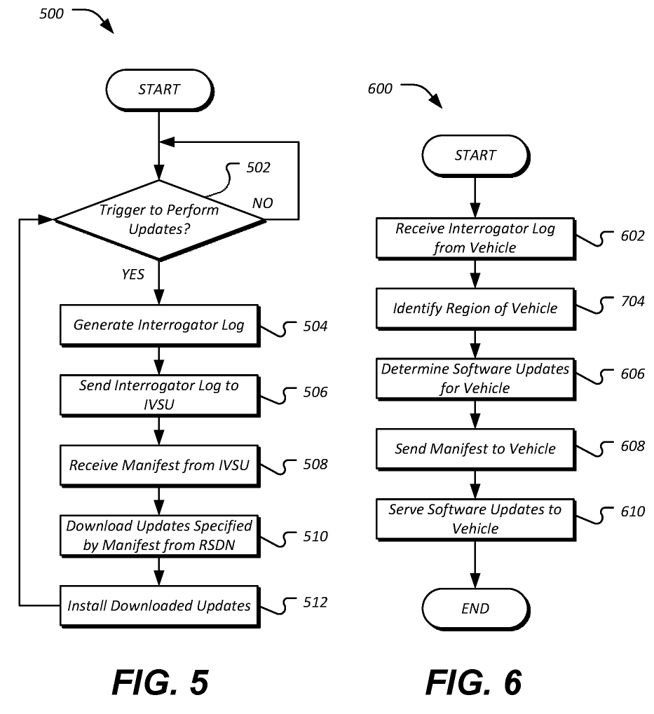

FIG. 5 illustrates an example process 500 for updating software of the computing platform 104 using a regional software delivery network 204. The process 500 may be performed, for example, by the computing platform 104 of the vehicle 102 in communication with the IVSU 202 and the RSDN 204 over the network 156.

At operation 502, the computing platform 104 determines whether a trigger has occurred to request software updates 220. For example, upon determining that a predetermined number of key-on cycles have been completed by the vehicle 102 and/or a predetermined amount of time has elapsed, and further that a network connection is available to communicate to the IVSU 202 (e.g., via a connected mobile device 152), the computing platform 104 may determine that the vehicle 102 should check for software updates.

At operation 504, the vehicle 102 generates an interrogator log 212. The interrogator log 212 may include version information of at least one software module installed on the vehicle 102. The information to interrogate may include, as some non-limiting examples, module name, module serial number, VIN, hardware part number, MAC address, part numbers of software applications, languages, and service packs installed on the module, available storage space on the module, and status information regarding the installation of previous updates. The computing platform 104 may be configured to generate the interrogator log 212 according to an ODL 214 defining what information to interrogate and where such information may be located. The information to interrogate may include, for example, requested identifiers from the computing platform 104 and other vehicle ECUs 148 within the vehicle 102. The information may be gathered via the CAN bus or other vehicle network 142, and included in the interrogator log 212. In some cases, the ODL 214 may be received as part of an installation of software on the vehicle 102, while in other cases the ODL 214 may have been previously received according to earlier performed updates.

At operation 506, the vehicle 102 sends the interrogator log 212 to the IVSU 202. In an example, the computing platform 104 may send the interrogator log 212 to the IVSU 202 via HTTPS (e.g., by connection of the computing platform 104 to a predefined web address of the IVSU 202 known to the computing platform 104).

At operation 508, the vehicle 102 receives a manifest 216 from the IVSU 202. The manifest 216 may indicate one or more binaries to be downloaded and installed by the vehicle 102, as well as other information to use when performing the update, such as updated ODL 214 and/or keys to decrypt the binaries to be downloaded and installed. In an example, the IVSU 202 may send the manifest 216 to the vehicle 102 via HTTPS (e.g., over the HTTPS connection to which the computing platform 104 sent the interrogator log 212 to the computing platform 104, over a different connection to the same or a different predefined web address of the IVSU 202 known to the computing platform 104, etc.).

At operation 510, the vehicle 102 downloads the software updates 220 specified by the manifest 216. For example, the computing platform 104 of the vehicle 102 may download the software updates 220 from the web server 218 of the regional software delivery network 204 network locations specified by the manifest 216.

At operation 512, the computing platform 104 installs the software updates 220. For example, the computing platform 104 may execute or otherwise apply the firmware update to the installed firmware version to update the firmware version. In some cases, the computing platform 104 may be further configured to send a message to the IVSU 202 to alert the IVSU 202 of success or failure of installation of the software updates 220. Upon receiving a message indicating success of the software update, the IVSU 202 may update its records of the installed configuration status of the vehicle 102. After operation 512, control passes to operation 502.

FIG. 6 illustrates an example process 600 for providing software updates 220 to a vehicle 102 from a regional software delivery network 204. The process 600 may be performed, for example, by the IVSU 202 and the RSDN 204 in communication with the computing platform 104 of the vehicle 102 over the network 156.

At operation 602, the IVSU 202 receives the interrogator log 212 from the vehicle 102. In an example, the interrogator log 212 may be received as discussed above in operation 506.

At operation 604, the IVSU 202 identifies the region of the vehicle 102. In an example, the region identifier 222 of the IVSU 202 may utilize IP geolocation to identify the current location of a vehicle 102 based on the IP address of the vehicle 102. The IP address of the vehicle 102 may be the origination address of the connection over which the interrogator log 212 is received to the IVSU 202. Using the originating address, the region identifier 222 of the IVSU 202 may derive the region (e.g., country, etc.) for the update request. Moreover, using the RSDN data 226 mapping of IP or other addresses of the regional software delivery networks 204 to identifiers of regions served by the respective regional software delivery networks 204, the region identifier 222 determines which of the regional software delivery networks 204 to use in constructing the manifest 216 for the vehicles 102.

At operation 606, the IVSU 202 determines the software updates 220 for the vehicle 102. In an example, the manifest creator 224 of the IVSU 202 identifies the software updates 220 to apply using the interrogator log 212, and generates the manifest 216 with links to those software updates 220 as hosted by the determined regional software delivery network 204.

At operation 608, the IVSU 202 sends the manifest 216 to the vehicle 102. In an example, the IVSU 202 returns the manifest 216 to the vehicle 102 via HTTPS. At operation 610, the RSDN 204 serves the software updates 220 to the vehicle 102. Accordingly, the vehicle 102 retrieves the determined software updates 220 from the RSDN 204 in the same region as the vehicle 102. After operation 608, the process 600 ends.

Computing devices described herein, such as those included in the computing platform 104, IVSU 202, and RSDN 204, generally include computer-executable instructions, where the instructions may be executable by one or more computing devices such as those listed above. Computer-executable instructions, such as those of the web servers 218, region identifier 222, and manifest creator 224, may be compiled or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a server programmed to:
identify, based on an originating address of a request from a vehicle for software updates, a regional software delivery network to serve the software updates to the vehicle,
determine the software updates to apply to the vehicle based on the request, and
send a manifest to the vehicle including links to the software updates served by the regional software delivery network.

2. The system of claim 1, wherein the server is further programmed to:
derive a region of the vehicle based on the originating address of the request; and
access data mapping originating addresses to identifiers of regions served by the regional software delivery networks to determine the regional software delivery network in the region of the vehicle.

3. The system of claim 2, wherein the region is a country, and each regional software delivery network is configured to serve software updates to a different country.

4. The system of claim 1, wherein the server is further programmed to:
receive the request from the vehicle over a secure hypertext protocol (HTTPS) connection, and
identify the originating address of the connection as an Internet Protocol (IP) address of the vehicle.

5. The system of claim 1, wherein the request includes an interrogator log and is received by the server via a secure hypertext protocol (HTTPS) post.

6. The system of claim 1, wherein the links to the software updates are specified as universal resource locators (URLs) served by one or more web servers of the regional software delivery network.

7. The system of claim 1, wherein the links to the software updates are specified as a base universal resource locators (URL) of the regional software delivery network and relative links to the base URL.

8. A method comprising:
mapping a network address of an update request from a vehicle to a geographic region;
identifying a regional software delivery network serving the geographic region; and
sending a response including links to software updates served by the regional software delivery network to the vehicle, the response generated based on information included in the update request.

9. The method of claim 8, wherein the geographic region is a country, and further comprising serving software updates by the regional software delivery network only to vehicles identified as within the country.

10. The method of claim 8, further comprising:
receiving the update request from the vehicle over a secure hypertext protocol (HTTPS) connection, and
identifying the network address as an originating Internet Protocol (IP) address of the connection.

11. The method of claim 8, further comprising receiving the information via a secure hypertext protocol (HTTPS) post.

12. The method of claim 8, further comprising specifying, in the response, the links to the software updates as universal resource locators (URLs) served by one or more web servers of the regional software delivery network.

13. The method of claim 8, further comprising specifying, in the response, the links to the software updates as a base universal resource locator (URL) of the regional software delivery network and relative links to the base URL.

14. A non-transitory computer-readable medium storing instructions that, when executed by at least one processor of a server, cause the server to:
identify, based on an originating Internet Protocol (IP) address of a secure hypertext protocol (HTTPS) connection from a vehicle, a regional software delivery network to serve the software updates to the vehicle;
determine the software updates to apply to the vehicle based on an interrogator log received from the vehicle over the connection; and
send a manifest to the vehicle including web links to the software updates served by the regional software delivery network.

15. The computer readable medium of claim 14, further storing instructions that when executed cause the server to:
identify the regional software delivery network of the geographic region to serve the software updates based on the IP address.

16. The computer readable medium of claim 15, wherein the IP address identifies a country.

17. The computer readable medium of claim 14, wherein the web links to the software updates are specified as universal resource locators (URLs) served by one or more web servers of the regional software delivery network.

18. The computer readable medium of claim 14, wherein the web links to the software updated are specified in the manifest as a base universal resource locators (URL) of the regional software delivery network and relative links to the base URL.
